(19) United States
(12) Patent Application Publication
(10) Pub. No.: US 2002/0140827 A1
(43) Pub. Date: Oct. 3, 2002

(54) Image processing apparatus and image reproducing apparatus

(75) Inventors: Noriyuki Okisu, Osakasayama-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO.

(21) Appl. No.: 10/105,478

(22) Filed: Mar. 25, 2002

(30) Foreign Application Priority Data
Mar. 30, 2001 (JP) 2001-100064

(51) Int. Cl. H04N 5/232

(52) U.S. Cl. 348/222.1

(57) ABSTRACT

Disclosed is an image processing apparatus capable of storing composite image data and reconstruction information of original image data used for computing operation to generate the composite image data in a state where both of the data is always associated with witch other. The format of a composite image file is divided into a tag area, a captured image recording area, and a thumbnail image recording area in which attribute information, a composite image, and a thumbnail image are recorded, respectively. Further, in the tag area, reconstruction information of the original image data used for computing operation to generate the composite image data is recorded. The reconstruction information has a pattern in which original image data is recorded as it is, a pattern in which differential data between the original image data and composite image data is recorded, and a pattern in which differential data between the original image data and another original image data is recorded.

This application is based on application No. 2001-100064 filed in Japan, the contents of which are hereby incorporated by reference.

### BACKGROUND OF THE INVENTION

1. Field of the Invention

The present invention relates to a technique of storing and reproducing composite image data obtained by performing a computing process on a plurality of images.

2. Description of the Background Art

A technique of generating an image with an increased video effect and a technique for improving picture quality by combining still pictures captured a plurality of times are known.

For example, Japanese Patent Application Laid-Open No. 10-108057 discloses a technique of obtaining image data in which all of subjects at different distances are focused by combining plural image data obtained by shooting while changing a focal point. The invention is not limited to the above example but also can obtain various video effects and improve the picture quality by combining a plurality of still images.

In the case of performing such an image combining process, there is a case such that the user wishes to change the result of the combining process depending on characteristics of a subject or a personal point of view of the user.

Japanese Patent Application Laid-Open No. 2000-307921 discloses a technique of holding original image data used for a computing process for generating a composite image as multi-shade data immediately after A/D conversion. A technique of storing differential data between a final image and an original image and composition parameters as an auxiliary file different from a file in which a final image is recorded is also disclosed.

However, there is no guarantee that image data generated by shooting is permanently stored in a specific position. Due to the limited capacity of a recording medium, the image data is moved later or sooner.

Under such circumstances, in Japanese Patent Application Laid-Open No. 2000-307921, information related to original image data is stored in another file, so that it is troublesome to manage files. There may be a case that due to loss of a file or the like, an original image cannot be recovered.

### SUMMARY OF THE INVENTION

The present invention is directed to an image processing apparatus.

The image processing apparatus includes: an image obtaining unit for obtaining a plurality of image data; a composite image generator for generating composite image data by composing the plurality of image data obtained by the image obtaining unit; and a file generator for generating a single file including the composite image data generated by the composite image generator and reconstruction information of each of the image data used for generating the composite image data.

With the configuration, composite image data and reconstruction information are stored in an indivisible manner, problems such that image data and reconstruction information cannot be associated with each other and any of the information is lost can be solved.

According to an aspect of the invention, in the image processing apparatus, the reconstruction information contains the image data obtained by the image obtaining unit.

Since the image data is recorded as it is as the reconstruction information, the image data can be reproduced.

According to another aspect of the invention, in the image processing apparatus, the reconstruction information contains differential data between the composite image data and the image data obtained by the image obtaining unit.

Since the differential data is recorded as the reconstruction information, the size of the composite image file can be reduced.

According to further another aspect of the invention, in the image processing apparatus, the file is conformed with a standardized image file format and the reconstruction information is recorded in an undefined area in the image file format.

Since the reconstruction information is written in an undefined area in the image file format, a general image file format can be used.

In a preferred embodiment of the invention, the image processing apparatus takes the form of a digital camera.

In the digital camera, a composite image file by which image data can be reconstructed can be output.

According to another aspect of the invention, an image processing apparatus includes: an image obtaining unit for obtaining a plurality of image data at different exposures; a composite image generator for combining the plurality of image data obtained by the image obtaining unit to thereby generate composite image data having the larger number of torn levels than that of the image data obtained by the image obtaining unit; and a file generator for generating a single file including the composite image data generated by the composite image generator and each of the image data used for generating the composite image data.

With the configuration, composite image data having the larger number of torn levels than that of the image data obtained by the image obtaining unit is generated. Thus, the composite image data having a wider dynamic range and the image data from which the composite image data is generated can be reproduced.

The present invention is also directed to an image reproducing apparatus.

The image reproducing apparatus includes: an input unit for inputting an image file recording composite image data and reconstruction information of a plurality of image data used for generating the composite image data; a first reproducer for reproducing the composite image data; a generator for generating reconstructed image of the plurality of image data in accordance with the reconstruction information; and a second reproducer for reproducing the reconstructed image generated by the generator.

By using the apparatus, even after elapse of time since composite image data is generated, the image data can be referred to.

The present invention is also directed to a software product adapted to the image processing apparatus and a software product adapted to the image reproducing apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing a personal computer for performing an image process and a digital camera.

FIG. 2 is a side view showing an internal configuration of a part of the digital camera.

FIG. 3 is a rear view of the digital camera in a state where an image capturing mode selection menu is displayed on an LCD.

FIG. 4 is an internal block diagram of the digital camera.

FIG. 5 is a diagram showing the format of an image file stored in a memory card in a normal image capturing mode.

FIG. 6 is a diagram showing the format of an image file stored in a tone adjusting mode.

FIG. 7 is a diagram showing the format of an image file stored in an out-of-focus adjusting mode.

FIG. 8 is a diagram showing the format of an image file in the case where original image data is stored as differential image data in the tone adjusting mode.

FIG. 9 is a diagram showing the format of an image file in the case where original image data is stored as differential image data in the tone adjusting mode.

FIG. 10 is a flowchart showing a tone adjusting process.

FIG. 11 is a flowchart showing a positioning process.

FIG. 12 is a diagram showing an image of the positioning process.

FIG. 13A is a diagram showing an A/D conversion output level with respect to the luminance level of the object and

FIG. 13B is a diagram showing a combining ratio between an image captured at overexposure and an image captured at underexposure in a tone controlling process.

FIG. 14 is a flowchart showing the procedure of image compressing and recording process.

FIG. 15 is a diagram showing a recording pattern setting menu.

FIG. 16 is a block diagram of a personal computer.

FIG. 17 is a flowchart showing an image reproducing process.

FIG. 18 is a diagram showing original image data and composite image data on a screen.

### DETAILED DESCRIPTION OF THE PREFERRED EMBODIMENTS

1. General Configuration and Image Processing Mode

Preferred embodiments of the invention will be described hereinbelow with reference to the drawings.

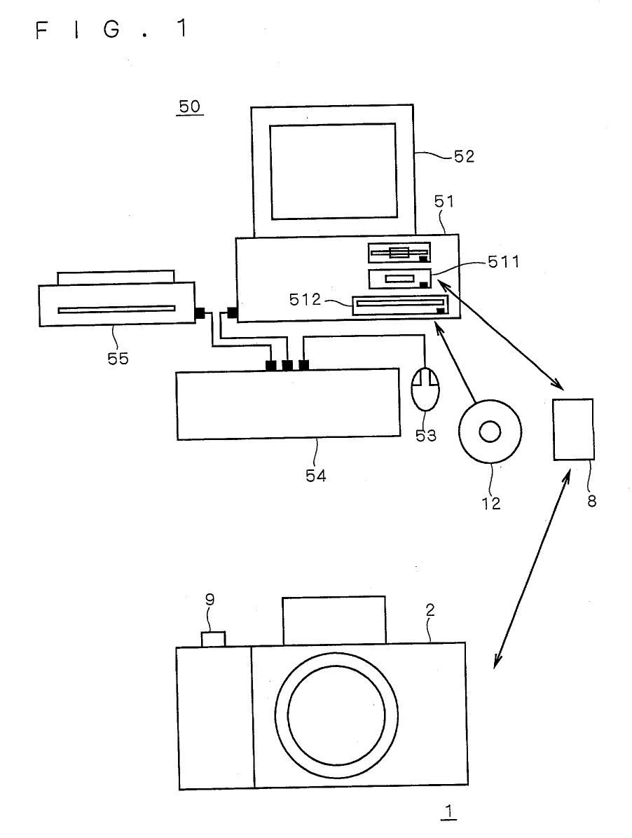

FIG. 1 shows a digital camera 1 and a personal computer 50 as a data processor for performing an image process on image data captured by the digital camera 1.

Image data captured by the digital camera 1 is recorded on, for example, a memory card 8. The operator pulls out the memory card 8 on which image data is recorded from the digital camera 1 and inserts the memory card 8 into a card slot 511 provided in a personal computer body 51. By image processing software or the like which operates on the personal computer 50, the image captured by the digital camera 1 can be viewed. By using image processing software, an image process can be executed on the captured image.

The image data captured by the digital camera 1 may be transferred to the personal computer 50 side by using a USB cable or the like. An image loaded in the personal computer 50 can be recognized on a display 52 or output to a printer 55 by using the image processing software.

The digital camera 1 has not only a normal image capturing mode but also an image capturing mode for performing a computing process on plural image data obtained by a plurality of image capturing operations and outputting a composite image file (hereinbelow, called an image processing mode).

The image processing mode is a mode of continuously shooting a subject a plurality of times while arbitrarily changing the image capturing parameters at the time of release, generating a composite image from a plurality of images captured by the shooting, and recording a generated composite image file into the memory card 8.

The digital camera 1 in the embodiment has, as image processing modes, “out-of-focus adjusting mode”, “tone adjusting mode”, “very high resolution mode”, and the like. The outline of the three image processing modes will be described hereinbelow. For simplicity, a case of generating one composite image data from two captured images A and B will be described as an example.

The “out-of-focus adjusting mode” is an image capturing mode of performing image capturing operation twice in a row while changing the focal position by a single shutter operation, thereby obtaining an image A in which focus is achieved on the main subject (for example, a person) and an image B in which focus is achieved on the background of the main subject. By combining the captured images A and B, an image having a desired degree of out-of-focus is generated.

The “tone adjusting mode” is an image capturing mode of performing image capturing operation twice in a row while changing an exposure parameter by a single shutter operation, thereby obtaining an image A in which an exposure is made at the main subject and an image B in which an exposure is made at the background of the main subject. By combining the captured images A and B, for example, an image having a proper density distribution over a whole screen or a very creative image having intentionally high contrast between the main subject and the background is generated.

The “very high resolution mode” is an image capturing mode of performing image capturing operation twice in a row without changing focus or exposure parameter by a single shutter operation to obtain two images A and B in which the positions of the main subject in a frame are slightly different due to slightly different camera angles in the first and second image capturing operations. By combining the images A and B having slightly different image capturing positions with respect to the main subject, an image having resolution higher than that of an original image is generated.

2. Configuration of Digital Camera

2-1 Schematic Configuration

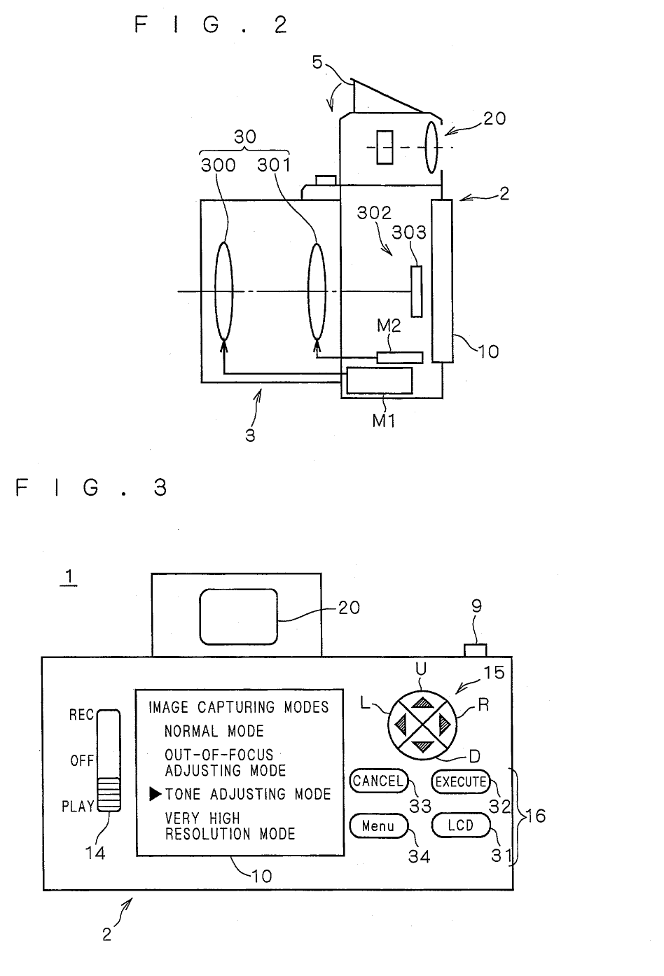

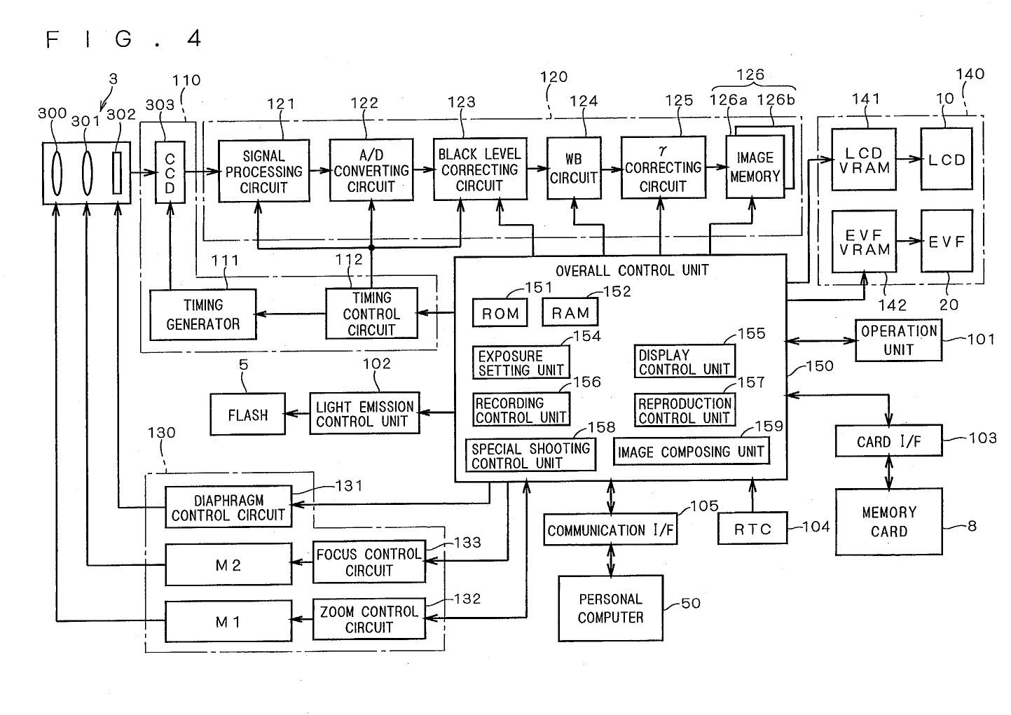

Referring to FIGS. 1, 2, and 3, a schematic configuration of the digital camera 1 will be described. FIG. 2 is a side view showing the internal configuration of a part of the digital camera 1 as an image processing apparatus according to the embodiment. FIG. 3 is a rear view of the digital camera 1.

The digital camera 1 is constructed by a camera body 2 having an almost rectangular parallelepiped shape and a lens unit 3 detachably attached to the camera body 2. As shown in FIG. 2, the lens unit 3 as a zoom lens with a macro function has a lens group 30 including a zoom lens 300 and a focusing lens 301. On the other hand, the camera body 2 has therein a zoom motor M1 for changing the zoom ratio of the zoom lens 300 and a focusing motor M2 for driving the focusing lens 301 to achieve focus. A color image pickup device 303 is provided in a proper rear position of the lens group 30 of the lens unit 3.

The color image pickup device 303 takes the form of a single color area sensor in which color filters of R (red), G (green), and B (blue) are adhered in a checker pattern on the surface of pixels of an area sensor made by a CCD. The color image pickup device (hereinbelow, called “CCD”) 303 has, for example, 1,920,000 pixels of 1600 pixels in the horizontal direction and 1200 pixels in the vertical direction.

A pop-up type built-in flash 5 is provided on the top of the camera body 2, and a shutter button 9 is provided at one end side of the top face of the camera body 2. The shutter button 9 has the function of detecting and determining a shutter touched state (S1) used as a trigger of focus adjustment or the like and a full pressed state (S2) used as a trigger of shooting for recording.

As shown in FIG. 3, en electronic view finder (hereinbelow, called “EVF”) 20 and a liquid crystal display (hereinbelow, called “LCD”) 10 are provided on the rear face of the camera body 2. Different from an optical finder, the EVF 20 and the LCD 10 for displaying a live view of image signals from the CCD 303 in an image capturing standby mode have the function of a finder.

The LCD 10 can display a menu screen for setting an image capturing mode, image capturing parameters, and the like in the recording mode and reproduce and display a captured image recorded on the memory card 8 in a reproduction mode. FIG. 3 shows a state where the menu screen is displayed.

In the left part of the rear face of the camera body 2, a power switch 14 is provided. The power switch 14 also serves as a mode setting switch for switching and setting a recording mode REC (mode of taking a picture) and a reproduction mode PLAY (mode for reproducing a recorded image onto the LCD 10).

In the right part of the rear face of the camera body 2, a four-way switch 15 is provided. The four-way switch 15 has a circular operation button. By pressing the buttons U, D, L, and R in the four directions of up, down, left, and right in the operation button, various operations can be performed. For example, the four-way switch 15 functions as a switch for changing an item selected on the menu screen displayed on the LCD 10 and changing a frame to be reproduced which is selected on an index screen. In the recording mode, the buttons R and L of the right and left directions function as a switch for changing the zoom ratio. When the right-direction switch R is depressed, the zoom lens 300 is continuously moved to the wide side by the driving of the zoom motor M1. When the left-direction switch L is depressed, the zoom lens 300 is continuously moved to the tele-side by the driving of the zoom motor M1.

Below the four-way switch 15, a group 16 of switches such as a cancel switch 33, an execution switch 32, a menu display switch 34, and an LCD display switch 31 are provided. The cancel switch 33 is a switch for canceling the item selected on the menu screen. The execution switch 32 is a switch for determining or executing the item selected on the menu screen. The menu display switch 34 is a switch for displaying the menu screen on the LCD 10 or switching the contents of the menu screen. The LCD display switch 31 is a switch for switching on/off of display of the LCD 10.

The user can open a menu screen for selecting an image capturing mode and select an image capturing mode by operating the four-way switch 15, switch group 16, and the like. The image capturing modes include a normal image capturing mode for performing normal image capturing operation every picture and an image processing mode (tone adjusting mode and the like).

2-2 Internal Block Configuration

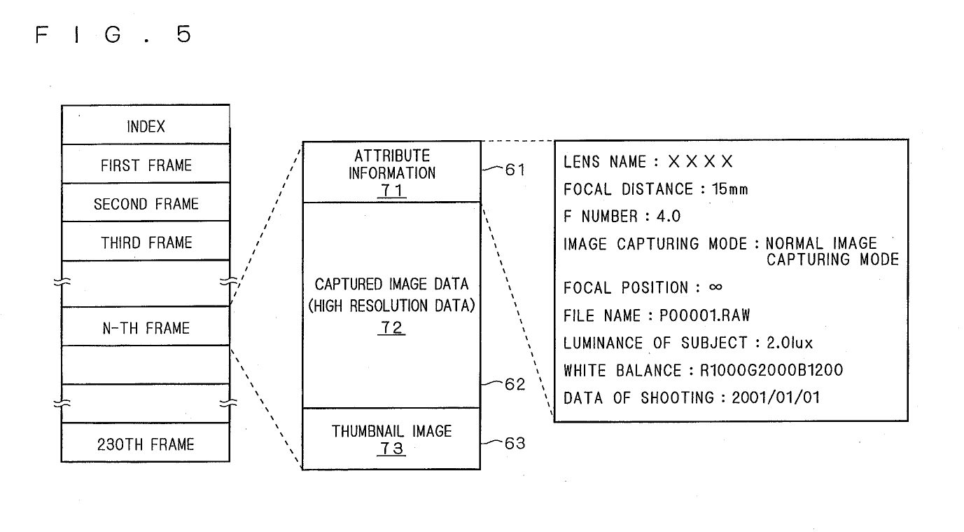

The internal configuration of the digital camera 1 will now be described. FIG. 4 is a schematic block diagram showing the internal configuration of the digital camera 1.

The lens unit 3 has therein, in addition to the zoom lens 300 and the focusing lens 301, and a diaphragm 302 for adjusting a transmission light amount.

An image capturing unit 110 photoelectrically converts a subject light source entered through the lens unit 3 into an image signal and has, in addition to the CCD 303, a timing generator 111 and a timing control circuit 112. Based on a drive control signal which is input from the timing generator 111, the CCD 303 receives the subject light source for predetermined exposure time, converts the light into an image signal, and outputs the image signal to a signal processing unit 120 by using a read control signal which is input from the timing generator 111. At this time, the image signal is separated into color components of R, G, and B and the color components are output to the signal processing unit 120.

The timing generator 111 generates the drive control signal on the basis of a control signal supplied from the timing control circuit 112, generates a read signal synchronously with a reference clock, and outputs the signal to the CCD 303. The timing control circuit 112 controls the image capturing operation of the image capturing unit 110. The timing control circuit 112 generates image capturing control signals on the basis of a control signal which is input from an overall control unit 150. The image capturing control signals include a control signal for capturing an image of the subject, a reference clock, and a timing control signal (sync clock) for processing the image signal output from the CCD 303 by the signal processing unit 120. The timing control signal is input to a signal processing circuit 121 and an A/D converting circuit 122 in the signal processing unit 120.

The signal processing unit 120 performs predetermined analog signal process and digital signal process on an image signal output from the CCD 303. The signal process on the image signal is performed every photoreception signal of each of pixels constructing image data. The signal processing unit 120 includes the signal processing circuit 121, the A/D converting circuit 122, a block level correcting circuit 123, a WB circuit 124, a γ correcting circuit 125, and an image memory 126.

The signal processing circuit 121 performs an analog signal process and mainly includes a CDS (correlation double sampling) circuit and an AGC (automatic gain control) circuit. The signal processing circuit 121 reduces sampling noise of a pixel signal output from the CCD 303 and adjusts the signal level. Gain control by the AGC circuit is also executed in the case of compensating an insufficient level of a captured image when proper exposure cannot be obtained by an f number of the diaphragm 302 and exposure time of the CCD 303.

The A/D converting circuit 122 converts a pixel signal as an analog signal output from the signal processing circuit 121 to pixel data as a digital signal. The A/D converting circuit 122 converts a pixel signal received by each pixel into, for example, a digital signal of 10 bits as pixel data having torn level values of 0 to 1023.

The black level correcting circuit 123 interpolates pixels subjected to A/D conversion and corrects the black level to a reference black level. The WB circuit 124 adjusts the white balance of a captured image. The WB circuit 124 adjusts the white balance of a captured image by shifting the level of pixel data of each of the color components R, G, and B by using a level shifting table input from the overall control unit 150. The γ correcting circuit 125 corrects the γ characteristic of pixel data. The γ correcting circuit 125 corrects the level of each pixel data by using a preset table for γ correction.

The image memory 126 is a memory for temporarily holding image data subjected to the signal process. The image memory 126 has two memory areas, to be specific, a first memory 126a and a second memory 126b so as to store image data of two frames. Each of the first and second memories 126a and 126b has a memory capacity capable of storing image data of one frame. In the embodiment, the number of pixels of the CCD 303 is 1,920,000 pixels, so that the capacity capable of storing 1,920,000 pixel data.

The digital camera 1 of the embodiment is constructed so as to generate a composite image by using two original image data. Consequently, the image memory 126 can store image data of two frames. In the case of generating a composite image by using three or more original image data, it is sufficient to assure the size of the image memory capable of storing the image data of the frames.

A light emission control unit 102 controls light emission of the flash 5 on the basis of a light emission control signal supplied from the overall control unit 150. The light emission control signal includes instruction to prepare for light emission, light emitting timing, and light emission amount.

A lens control unit 130 controls driving of members which are the zoom lens 300, focusing lens 301, and diaphragm 302 in the lens unit 3. The lens control unit 130 has a diaphragm control circuit 131 for controlling the f number of the diaphragm 302, a zoom control circuit 132 for controlling the driving of the zoom motor M1, and a focus control circuit 133 for controlling the driving of the focusing motor M2.

The diaphragm control circuit 131 drives the diaphragm 302 on the basis of the f number supplied from the overall control unit 150 and sets the aperture of the diaphragm 302 to the f number. The focus control circuit 133 controls the driving amount of the focusing motor M2 on the basis of an AF control signal input from the overall control unit 150 to set the focusing lens 301 in a focus position. The zoom control circuit 132 drives the zoom motor M1 on the basis of the zoom control signal input from the overall control unit 150 to move the zoom lens 300 in the direction designated by the four-way switch 15.

A display unit 140 displays image data to the LCD 10 and EVF 20. The display unit 140 has not only the LCD 10 and EVF 20 but also an LCD VRAM 141 as a buffer memory of image data reproduced and displayed on the LCD 10, and an EVF VRAM 142 as a buffer memory of image data reproduced and displayed on the EVF 20.

In the image pickup standby mode, pixel data of an image captured every 1/30 second by the CCD 303 is subjected to a predetermined signal process by the signal processing unit 120 and temporarily stored in the image memory 126. The data is read by the overall control unit 150. After adjusting the data size, the resultant data is transferred to the LCD VRAM 141 and EVF VRAM 142, and displayed as a live view on the LCD 10 and the EVF 20. Consequently, the user can visually recognize the subject image. In the reproduction mode, an image read from the memory card 8 is subjected to a predetermined signal process by the overall control unit 150 and, after that, the processed image is transferred to the LCD VRAM 141, and reproduced and displayed on the LCD 10.

An RTC 104 is a clock circuit for managing image capturing dates. Image capturing date obtained here is associated with captured image data and the resultant is stored in the memory card 8.

An operation unit 101 is used to enter operation information of the above-described operating members related to image capturing and reproduction provided for the camera body 2 into the overall control unit. The operation information entered from the operation unit 101 includes operation information of the operating members such as the shutter button 9, power switch 14, four-way switch 15, and switch group 16.

The overall control unit 150 takes the form of a microcomputer and controls the image capturing function and the reproducing function in a centralized manner. The memory card 8 is connected to the overall control unit 150 via a card interface 103. A personal computer is also externally connected via a communication interface 105.

The overall control unit 150 has a ROM 151 in which a process program for performing various concrete processes in the image capturing function and reproducing function and a control program for controlling the driving of the members of the digital camera 1 are stored, and a RAM 152 as a work area for performing various computing works in accordance with the processing program and control program. Program data stored in the memory card 8 as a recording medium can be read via the card interface 103 and stored into the ROM 151. Therefore, the process program and control program can be installed from the memory card 8 to the digital camera 1. The process program and control program may be installed from a personal computer PC via the communication interface 105.

In FIG. 4, an exposure setting unit 154, a display control unit 155, a recording control unit 156, a reproduction control unit 157, a special shooting control unit 158, and an image composing unit 159 are functional blocks expressing functions realized by the process program of the overall control unit 150.

The exposure setting unit 154 performs an exposure control process for determining the luminance of the subject by using image data of the color component of G in a live view image and computing an exposure control value on the basis of the determination result.

The display control unit 155 performs an image displaying process and performs a displaying operation of the display unit 140, specifically, an operation of reading image data temporarily stored in the image memory 126, adjusting the image size to the image size of a display destination as necessary, and transferring the resultant to the LCD VRAM 141 or EVF VRAM 142.

The recording control unit 156 performs a process of recording an image, attribute information, or the like, and will be specifically described hereinlater. The reproduction control unit 157 performs a process of reproducing a captured image recorded on the memory card 8 into the LCD 10.

For example, when the image capturing mode is set to the tone adjusting mode, the special shooting control unit 158 controls exposing operation of the CCD 303 when the shutter button 9 is pressed (S2). When the shutter button 9 enters the state of S2, the special shooting control unit 158 controls to perform exposing operation twice at a predetermined interval while changing the exposure time of the CCD 303 corresponding to the shutter speed to take images for composition to be subjected to a tone adjusting process.

The image composing unit 159 performs a process of combining plural image data captured in the image processing mode. For example, in the tone adjusting mode, the process of combining two image data obtained at different exposures is performed. In the combining process, positioning of the two images (positioning process) is performed and the images are added at a proper addition ratio, thereby performing a process of generating an actual composite image (image combining process). The details will be described hereinlater.

3. Image Recording Method and Storing Form

An image recording method and a storing form in the image processing mode as a feature part of the invention will now be described. First, the case of the normal image capturing mode for recording an image in a conventional manner will be described first.

3-1 Recording Method in Normal Image Capturing Mode

In the normal image capturing mode, the recording control unit 156 reads image data temporarily stored in the image memory 126 after an image capturing instruction, stores it into the RAM 152 and performs a predetermined compressing process by the JPEG method such as two-dimensional DCT or Huffman coding, thereby generating image data for recording as captured image data.

By reading out pixel data from the image memory 126 and writing it to the RAM 152 every 8 pixels in both vertical and lateral directions, thumbnail image data is generated. Further, attribute information regarding captured image data recorded by being attached to the captured image data is generated. The recording control unit 156 generates an image file obtained by attaching attribute information to the compressed captured image data and thumbnail image data and records the image file into the memory card 8.

FIG. 5 is a diagram showing a method of recording an image file to the memory card 8 in the normal image capturing mode. In a recording area at the head of the memory card 8, an index area for storing management information of the image file is provided. In the following area, image files are stored in accordance with the capturing order.

The storage area of each image file in the memory card 8 consists of three areas of a tag area 61, a captured image recording area 62, and a thumbnail image recording area 63 in which attribute information 71, captured image data (high resolution data) 72, and thumbnail image data 73 are recorded, respectively.

As shown in the diagram, the attribute information 71 includes items such as “lens name”, “focal distance at the time of shooting”, “aperture valve at the time of shooting”, “image capturing mode”, “focal position”, “file name”, “subject luminance”, and “white balance adjustment value”. In the item of “image capturing mode”, information indicating whether the image is captured in the normal image capturing mode or the image processing mode such as a tone adjusting mode is recorded.

Such a recording method is standardized as a general image file format. Therefore, by opening an image file by using general image processing software, the captured image data and thumbnail image data can be displayed, and the attribute information can be referred to.

3-2 Recording Method in Image Processing Mode

A method of recording composite image data captured in the image processing mode will now be described. In the explanation as well, the case of generating one composite image data from two original image data will be described as an example.

In the case of capturing images in the image processing mode, as described above, one composite image is generated from two captured images A and B. In the embodiment, in the memory card 8, reconstruction information of the captured images A and B (original image data A and B) and composite image data are recorded in one image file.

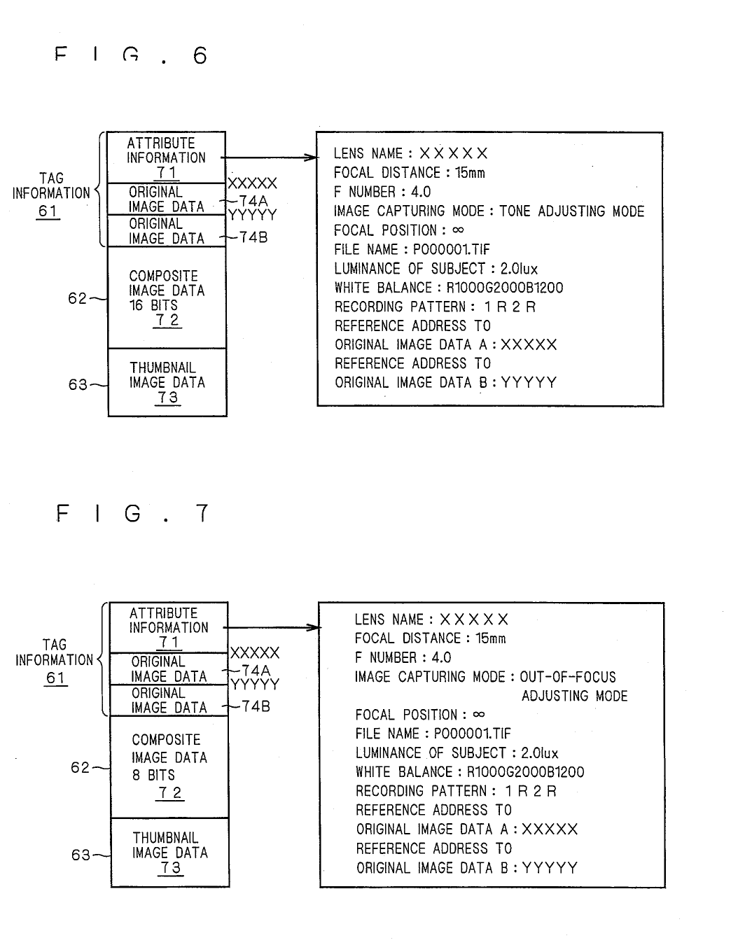

FIG. 6 is a diagram showing a method of recording an image captured in the “tone adjusting mode”. In the case where an image is captured in the “tone adjusting mode”, the composite image data 72 is recorded as captured image data in the captured image recording area 62. A process of generating the composite image data 72 will be described hereinlater. By the process of computing the original image data A and B, a composite image having a proper density distribution in the whole screen or a very creative composite image with an intentionally increased contrast between the main subject and the background is generated.

In the tag area 61, in a manner similar to the normal image capturing mode, the attribute information 71 regarding the composite image data 72 is recorded and, in addition, reconstruction information 74A and 74B of the original image data A and B is recorded. In the example shown in FIG. 6, original image data A and B is recorded as it is as the reconstruction information 74A and 74B. In the thumbnail image recording area 63, the thumbnail image data 73 of the composite image data 72 is recorded.

In the “image capturing mode” item in the attribute information 71, “tone adjusting mode” is recorded, so that image data recorded in the captured image recording area 62 can be identified as composite image data captured in the “tone adjusting mode” and generated. Therefore, by referring to the item by using predetermined image processing software, the image process performed on the image data can be recognized and a process according to the contents can be performed.

In the case where the image is captured in the image processing mode, information of a recording pattern is recorded in the attribute information 71. In the example shown in FIG. 6, “1R2R” is recorded in the “recording pattern”. The pattern indicates that each of the original image data is recorded as it is as the reconstruction information 74A of the “first” original image data and the reconstruction information 74B of the “second” original image data, respectively.

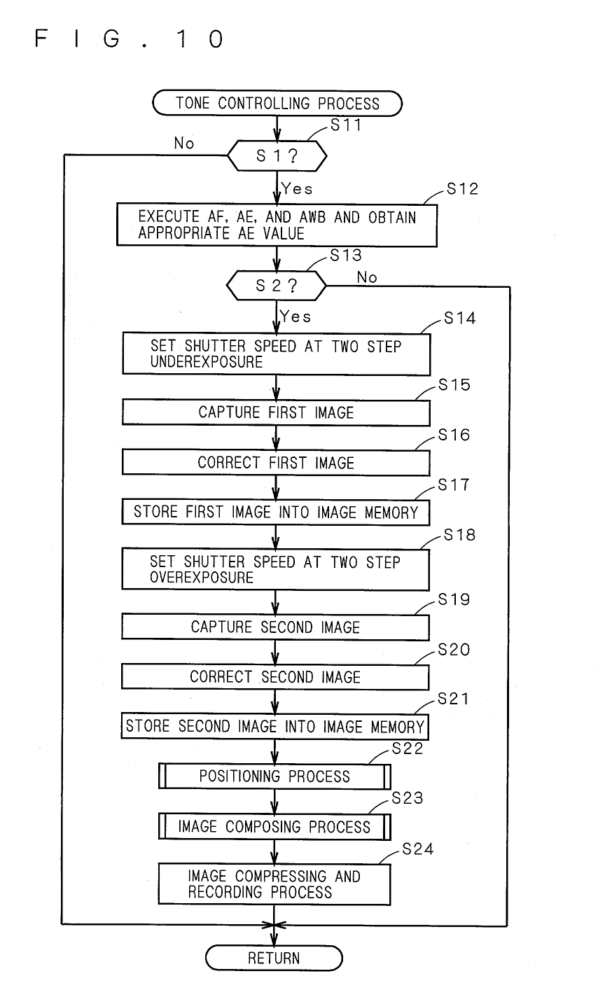

The image file shown in FIG. 8 is a file in which an image similarly captured in the “tone adjusting mode” is recorded, and the composite image data 72 subjected to the tone adjusting process is recorded in the captured image recording area 62. However, different from the example shown in FIG. 6, as the reconstruction information 74A and 74B recorded in the tag area 61, each of the original image data A and B is not recorded as it is respectively, but differential image data between the composite image data and the respective original image data A and B is recorded, respectively.

In the case of such a recording method, “1D2D” is recorded in the “recording pattern” item in the attribute information 71. The pattern indicates that only a difference between the reconstruction information 74A of the “first” original image data and the composite image data 72 and only a difference between the reconstruction information 74B of the “second” original image and the composite image data 72 are recorded as data of “D”.

By recording differential image data as mentioned above, the original image data A and B can be reconstructed. As compared with the case where the original image data is stored as it is, the size of the whole image file can be reduced.

Different from a personal computer or the like having a hard disk of a large capacity, in the case of a digital camera, captured image data is recorded in the memory card 8 of the limited capacity. Therefore, it is significant to reduce the data size of the image file.

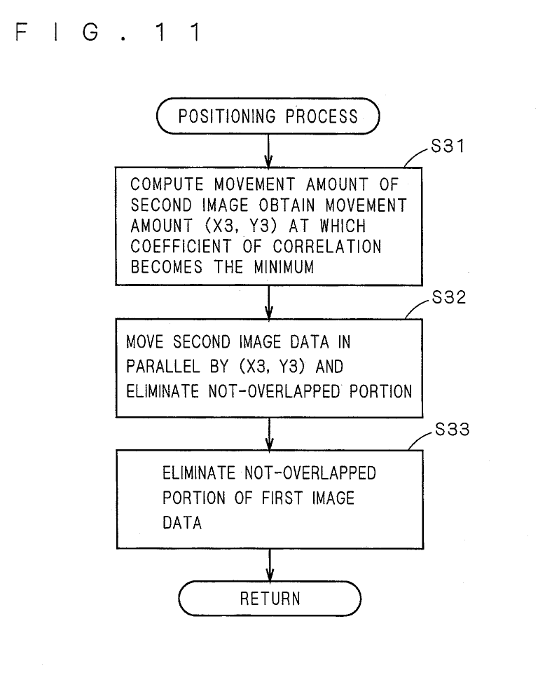

The image file shown in FIG. 9 is a file in which an image similarly captured in the “tone adjusting mode” is recorded. In the captured image recording area 62, therefore, the composite image data 72 subjected to the tone adjusting process is recorded.

“1R2d” is recorded in the “recording pattern”. It shows that the original image data A is recorded as it is as the reconstruction information 74A of the “first” original image data, and differential data between the reconstruction information 74B of the “second” original image data and the first original image data A is recorded. In such a manner, the size of an image file is reduced.

In each of the examples shown in FIGS. 6, 8, and 9, the recording methods of the reconstruction information 74A of the original image data A and that of the reconstruction information 74B of the original image data B are different from each other. In any of the cases, the generated composite image data 72 and information for reconstructing the original image data A and B are integrally recorded in the composite image file. By referring to the “recording pattern” item, the recording format of the original image data can be specified.

In the image file output in the image processing mode, the address of original image data (reconstruction information) is recorded in the “reference address” item in the attribute information 71. In the case of processing a composite image file recorded by the digital camera 1 according to the embodiment by the image processing software on a personal computer, by checking the “reference address” in the attribute information 71, original image data (reconstruction information) can be read.

Separately from the attribute information 71 of the composite image data 72, attribute information of original image data A and B may be stored in the areas of the reconstruction information 74A and 74B, respectively. Further, reversible compression may be performed on the reconstruction information 74 and composite image data.

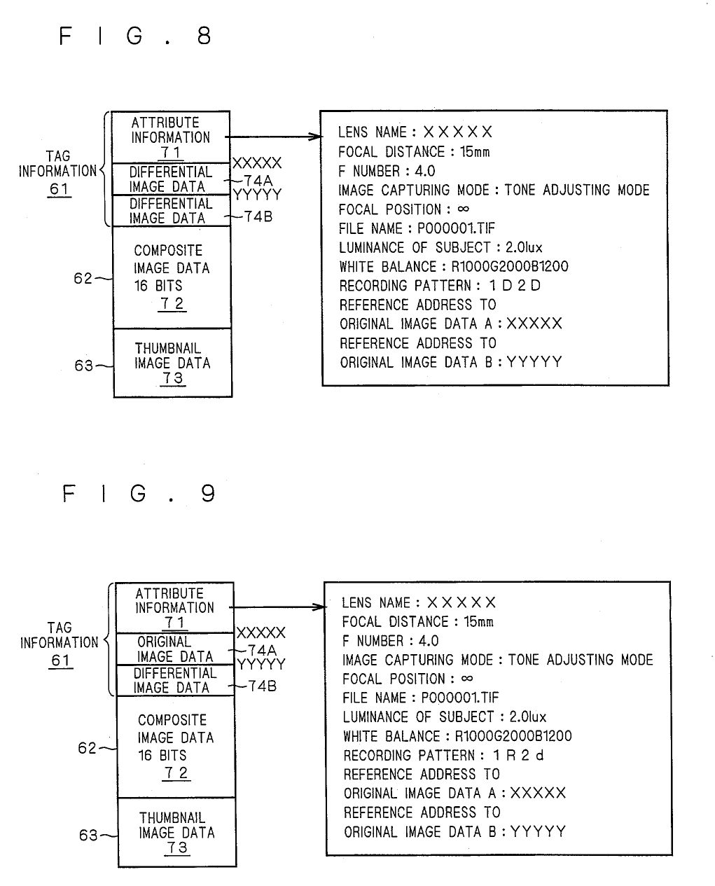

FIG. 7 shows the recording method of a composite image file output in the “out-of-focus adjusting mode”. In the “image capturing mode” item in the attribute information 71, the “out-of-focus adjusting mode” is recorded. Consequently, by referring to the item by using predetermined image processing software, an image file can be recognized as an image file captured in the “out-of-focus adjusting mode” and generated by being subjected to the out-of-focus adjusting process.

“1R2R” is written in the “recording pattern” item and indicates that each of the original image data A and B is recorded as the reconstruction information 74A and 74B of the original image data A and B, respectively. As composite image data captured in the “out-of-focus adjusting mode”, the reconstruction information 74 can be recorded as different image data as shown in the examples of FIGS. 8 and 9.

As described above, the recording control unit 156 generates an image file according to a mode which may be any of the normal image capturing mode and the image processing mode. In the image processing mode, the reconstruction information 74 is recorded in an undefined area in the tag area 61. That is, for the reconstruction information 74, the undefined area open to the user in the tag information 61 is used. The composite image file is conformed with a standardized image file format such as TIFF (Tag Image File Format). Consequently, by using general image processing software, a captured image (composite image) and a thumbnail image can be displayed, and the attribute information 71 can be referred to by dedicated software which will be described hereinlater.

4. Tone Adjusting Process

The image capturing operation and image combining process in an image processing mode of the digital camera 1 configured as described above will now be described by using the “tone adjusting mode” as an example. FIG. 10 is a flowchart showing the procedure of an image capturing operation and the procedure of a combining process in the “tone adjusting mode”.

In step S11, when the shutter button 9 is touched, as preparation for capturing an image, the focus of the lens group 30 of the lens unit 3 is adjusted on the main subject, an exposure control value is calculated by using a live view image, and a white balance adjustment value is set. The exposure control value calculated at this time is a value of proper exposure and, concretely, a shutter speed and an f number as proper values are obtained (step S 12).

Subsequently, when the shutter button 9 is pressed in step S13, a shutter speed at two step underexposure with respect to the shutter speed as a proper value is set (step S14). The CCD 303 is exposed only for exposure time corresponding to the shutter speed and a first image F1 of the subject is captured (step S15). After exposure, an image signal output from the CCD 303 is subjected to a predetermined analog signal process by the signal processing circuit 121 and converted to pixel data of 10 bits by the A/D converting circuit 122.

Subsequently, a correcting process such as black level correction and WB correction is performed (step S16) and the result is stored in the first memory 126a of the image memory 126 (step S17).

Since the exposure time of the CCD 303 is set to be shorter than the proper value, the exposure is smaller than that of an image captured in the normal image capturing mode, so that the first image F1 is a generally darkish image.

A shutter speed at two step overexposure with respect to the shutter speed as a proper value is set (step S18) and the CCD 303 is exposed for exposure time corresponding to the shutter speed, and a second image F2 of the subject is captured (step S19). After the exposure, in a manner similar to the first image F1, an image signal output from the CCD 303 is subjected to a predetermined analog signal process by the signal processing circuit 121, converted to pixel data of 10 bits by the A/D converting circuit 122, and subjected to a correcting process similar to that of the first image, and the resultant is stored in the second memory 126b of the image memory 126 (steps S20 and S21).

Since the exposure time of the CCD 303 is set longer than the proper value, the exposure is longer than that of an image captured in the normal image capturing mode, and the second image F2 is a generally light image.

Subsequently, in response to storage of the second image F2 into the second memory 126b of the image memory 126, the image composing unit 159 in the overall control unit 150 reads out the first and second captured images F1 and F2 from the image memory 126, and performs a process of positioning the images (step S22). The positioning process is performed to position the images to be combined. In this case, the first image F1 is used as a reference image and the second image F2 is moved.

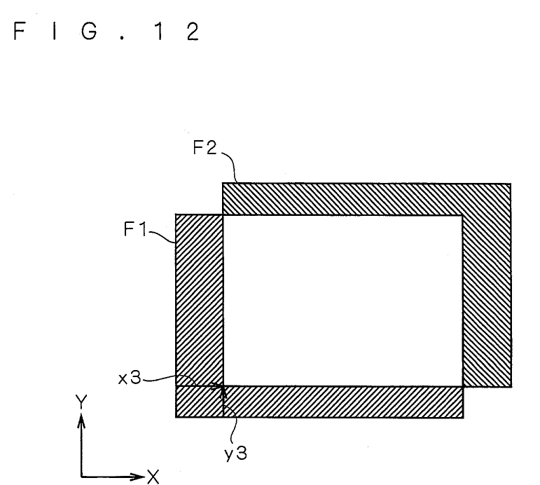

FIG. 11 is a flowchart showing the flow of the positioning process. In step S31, a shift amount in a rectangular XY plane coordinate system of the second image F2 is calculated. Specifically, on assumption that the second image F2 is parallel shifted in the X and Y directions, and the shift amount by which a correlation coefficient C(ξ, η) expressed by the following equation 1 becomes the minimum is calculated.

C(ξ, η)=ΣΣ{P1(x,y)−P2(x−ξ,y−η)}² (Equation 1)

where x and y are coordinate variables in the rectangular XY plane coordinate system having the center of an image as an origin, P1 (x, y) denotes the level of pixel data in the coordinate position (x, y) of the first image F1, and P2(x−ξ, y−η) expresses the level of pixel data in the coordinate position (x−ξ, y−η) of the second image F2. That is, the correlation function C(ξ, η) expressed by the expression 1 is obtained by squaring the level difference of pixel data corresponding to both images and totaling the resultant with respect to all of pixel data. When a value (ξ, η) as a shift amount of the second image F2 is changed, the value (ξ, η) at which the correlation coefficient C becomes the minimum is the shift amount of the second image F2 at which the patterns of the images match with each other the most.

In the embodiment, for example, by changing ξ as the shift amount of the X coordinate of the second image F2 from −80 to +80 and changing n as a shift amount of the Y coordinate from −60 to +60, the shift amount (ξ, η) at which the correlation coefficient C becomes the minimum is calculated as (x3, y3). It is sufficient to properly set the shift amounts ±80 and ±60 of X and Y in accordance with the image size and an expected deviation amount. In the tone control mode, since the first and second images F1 and F2 are captured with different exposure time of the CCD 303, there is a luminance level difference of the whole images. Consequently, it is preferable to normalize the data of both images by dividing each of image data by an average luminance and, after that, calculate the correlation coefficient C.

In the positioning process, only the color component of G which exerts a large influence on the resolution from the viewpoint of the visual characteristic of a human being may be used. In such a case, by using the shift amount calculated with the G color component for the color components of R and B which exert a smaller influence on the resolution from the viewpoint of the visual characteristic of a human being, the positioning process can be simplified.

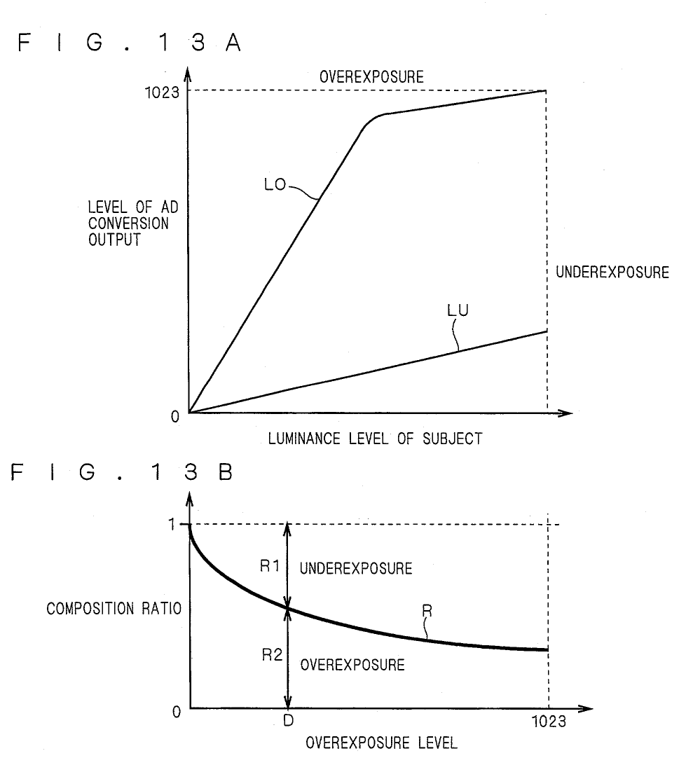

Subsequently, in step S32, as shown in FIG. 12, the second image F2 is parallel shifted by the calculated shift amount (x3, y3). After the parallel shift, a portion in the pixel data of the second image F2, which is not overlapped with the first image F1 is deleted. In step S33, the pixel data of a portion in the first image F1, which is not overlapped with the second image F2 is deleted. In such a manner, the pixel data in the portion which is not necessary for image combining (the hatched portions in FIG. 12) is deleted, thereby enabling only the accurately positioned pixel data necessary for combining can be obtained.

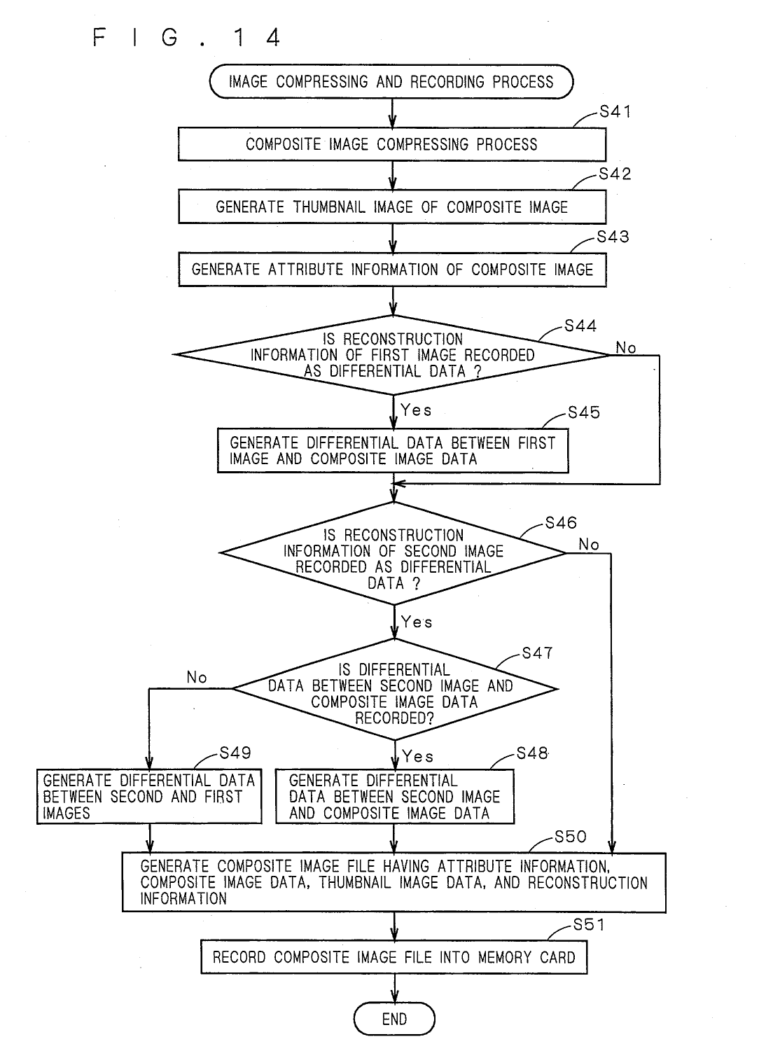

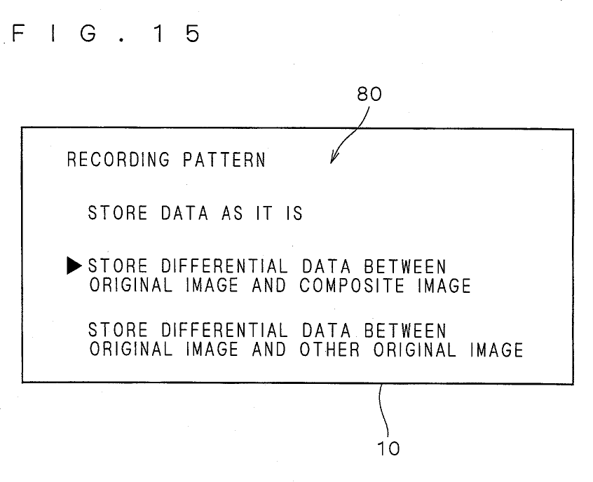

Subsequently, by the image composing unit 159 in the overall control unit 150, a combining process is performed on the positioned images (step S23 in FIG. 10). The A/D conversion output level with respect to the luminance level of the subject in the first and second images F1 and F2 will be described here. As shown in FIG. 13A, the exposure of the first image F1 captured at underexposure is suppressed, so that the tone characteristic is shown by a characteristic LU, that is, the A/D conversion output level for a luminance level of the subject is suppressed to be relatively low. On the other hand, the second image F2 is captured at overexposure. As the tone characteristic is shown by the characteristic LO, the A/D conversion output level is relatively high and emphasized with respect to the luminance level of the subject.

In the image combining process, by adding the image data of the first image F1 and the image data of the second image F2 at a proper addition ratio every pixel, image data having an arbitrary tone characteristic within the range between the tone characteristics LU and LO of FIG. 13A is generated.

FIG. 13B is a diagram showing the addition ratio at each level by the curve R with respect to the level of the second image F2 captured at overexposure as a reference. As shown in the diagram, the addition ratio is not constant irrespective of the level of image data but is changed so that the addition ratio (composition ratio) of the second image F2 captured at overexposure is increased as the overexposure level of the second image F2 captured at overexposure decreases. The reason why the addition ratio of the second image F2 captured at overexposure is increased is to make the darkish portion in the subject easily seen.

Concretely, when it is assumed that a level P2(i, j) of pixel data in the coordinate position (i, j) of the second image F2 is, for example, D as shown in the diagram, the level P2(i, j) of the pixel data and the level P1 (i, j) of the pixel data of the coordinate position (i, j) of the first image F1 are added at R2:R1, thereby generating a level P3(i, j) of the pixel data of a tone-controlled composite image. By adding all the pixel data at the addition ratio according to the level of the pixel data of the second image F2 captured at overexposure, all the pixel data of the tone-controlled composite image can be generated.

As a result, a tone-controlled composite image having the tone characteristic which is intermediate between the tone characteristic of the first image F1 and the tone characteristic of the second image F2 is generated. The composite image is generated as image data in a file format having the number of torn levels of 16 bits with respect to each of the colors R, G, and B. Since the first and second images F1 and F2 are image data having the number of torn levels of 10 bits with respect to each of the colors R, G, and B, it can be adopted to hold the tone of the original data in the adding process. However, the file format of image data to which image processing software which operates on a personal computer or the like is adapted has generally the number of torn levels of 8 bits or 16 bits, and it is preferable to adopt the larger number of torn levels than that of the original data. In the embodiment, therefore, as a format more adapted to the reality, data having the number of torn levels of 16 bits as a file format is used as image data generated by the tone adjusting process (refer to FIGS. 6, 8, and 9).

Subsequently, an image compressing and recording process (step S24) is performed. By referring to the flowchart of FIG. 14, the image compressing and recording process will be described.

In the recording control unit 156 in the overall control unit 150, a reversible compressing process such as LZW is performed on the generated composite image, thereby generating the composite image data 72 (step S41). Simultaneously, the thumbnail image data 73 and attribute information 71 are generated (steps S42 and S43). The compressing process of step S41 may be omitted.

In the “image capturing mode” item in the attribute information 71, the “tone adjusting mode” is recorded. In the “recording pattern” item, the recording pattern of the reconstruction information 74 is recorded. The recording pattern of the reconstruction information 74 may be generated according to information preset by the operator or the operator may select a recording pattern during the series of tone adjusting processes shown in FIG. 10.

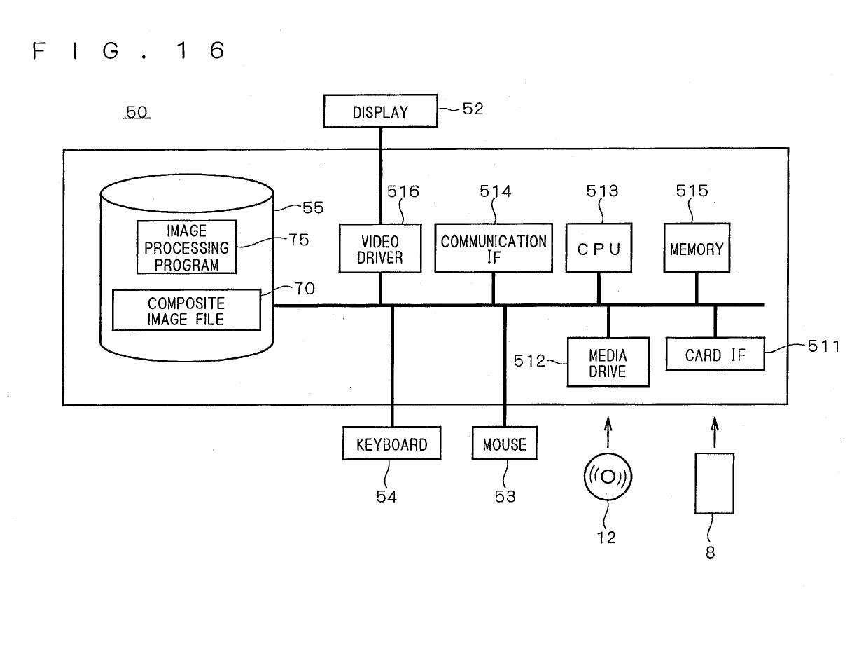

FIG. 15 shows a state where a recording pattern selection menu 80 is displayed on the LCD 10. The operator can select a desired recording pattern by operating the four-way switch 15, switch group 16, and the like. When the operator presets a recording pattern, the operator allows the selection menu 80 to be displayed on the LCD 10 by operating the switch group 16, sets the recording pattern, and captures an image in the image processing mode. In the case of the method of selecting the recording pattern during the series of the tone adjusting process, during the tone adjusting process, the selection menu 80 is displayed on the LCD 10, the operator performs a selecting operation, and the process is continued.

After that, reconstruction information is generated. In the case of recording the reconstruction information 74A of the first image F1 as differential image data (Yes in step S44), differential image data between the first image F1 and the composite image data is generated (step S45). By the above, the reconstruction information 74A of the first image F1 is generated. In the case of recording the reconstruction information 74A as it is as the first image F1 (No in step S44), differential data is not generated, and the data of the first image F1 is used as it is as the reconstruction information 74A.

In the case of recording the reconstruction information 74B of the second image F2 as differential image data (Yes in step S46), further, whether the differential image data is generated as differential data between the second image F2 and the composite image data or as differential data between the first image F1 and the second image F2 is determined (step S47). According to a result of determination, differential data between the second image F2 and composite image data is generated (step S48) or differential data between the first image F1 and the second image F2 is generated (step S49). In such a manner, the reconstruction information 74B of the second image F2 is generated. In the case of recording the reconstruction information 74B of the second image F2 as it is (No in step S46), no differential data is generated, and the data of the second image F2 is used as it is as the reconstruction information 74B.

As shown in FIGS. 6 to 9, the attribute information 71, composite image data 72, and thumbnail image data 73 is stored into the tag area 61, captured image recording area 62, and thumbnail image recording area 63, respectively. Further, the reconstruction information 74A and 74B of the first and second images F1 and F2 (corresponding to the original image data A and B) is stored in the tag area 61, and a composite image file is generated (step S50). The generated composite image file is recorded in the memory card 8 (step S51).

As described above, the digital camera 1 according to the embodiment integrally stores, as a file, the reconstruction information of the original image data used for a computing process to generate a composite image. Since the composite image and the original image are indivisible in the composite image file obtained by the digital camera 1, a problem such that the composite image and the original image cannot be associated with each other and a problem of loss of original image can be solved.

Although γ correction is not performed on the first and second images F1 and F2 but the γ characteristic is corrected in the combining process in the above-described tone adjusting process, it is also possible to perform a γ correcting process on the first and second images F1 and F2 and record the resultant as an image file into the image memory 126.

Although the “tone adjusting mode” has been described as an example of the image capturing operation and combining operation, also in the image processing mode such as the “out-of-focus adjusting mode” or “very high resolution mode”, similarly, data of an original image used for a computing process to generate composite image data is stored integrally with the composite image data into a composite file.

The “out-of-focus adjusting mode” and “very high resolution mode” do not have the purpose of widening the tone width. Therefore, a process of increasing the number of torn levels of composite image data generated as described in the tone adjusting process is not performed. In an image file shown in FIG. 7, the composite image data 72 captured in the out-of-focus adjusting mode is 8-bit image data of each of the R, G, and B colors. That is, 10-bit image data which is output after A/D conversion is converted into 8-bit image data by the γ correcting process. The image composing unit 159 generates an image file corresponding to 8-bit composite image data from the 8-bit original image data in the out-of-focus adjusting process. As described above, according to the purpose of a process, the number of torn levels of a file for storing composite image data is selected.

5. Display of Composite Image Data

In the digital camera 1 according to the embodiment, composite image data and the reconstruction information of original image data is recorded integrally in a composite image file. A method of reproducing the composite image file generated in such a manner by the image processing apparatus will now be described.

In the embodiment, the image processing apparatus is constructed by the personal computer 50, an image processing program 75 installed in the personal computer 50, and the like.

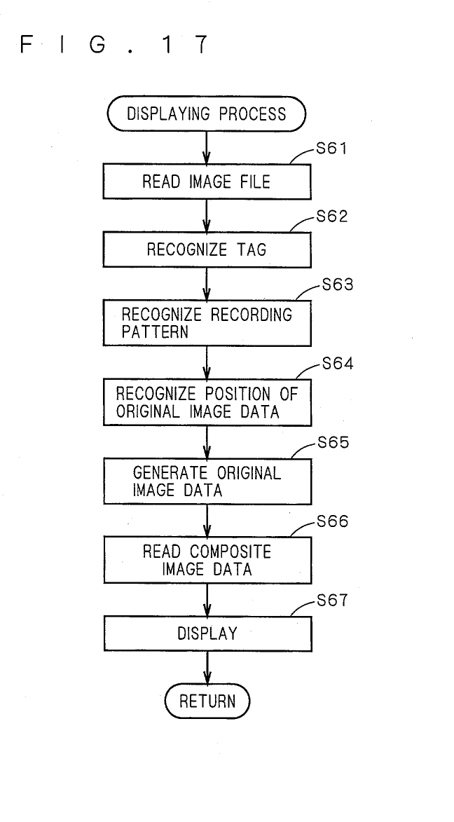

As shown in FIGS. 1 and 16, an operation part including a mouse 53 and a keyboard 54 and the display 52 are connected to the personal computer 50. The body of the personal computer 50 includes a CPU 513, a memory 515, a video driver 516, and a hard disk 55. In the hard disk 55, the image processing program 75 is stored. By controlling the video driver 516, an image file or the like is displayed on the display 52.

The personal computer 50 has, as interfaces with the outside, the card IF 511 and a communication IF 514. A program operating on the CPU 513 can read data in the memory card 8 via the card IF 511 and can communication with the outside via the communication IF 514. The communication IF 514 includes a USB interface, a LAN interface, and the like.

The personal computer 50 has a recording media drive 512 and can access a medium such as a CD-ROM or DVD-ROM inserted in the recording media drive 512.

The image processing program 75 according to the embodiment may be provided via a medium 12 or supplied from a server or the like on the Internet or LAN via the communication IF 514.

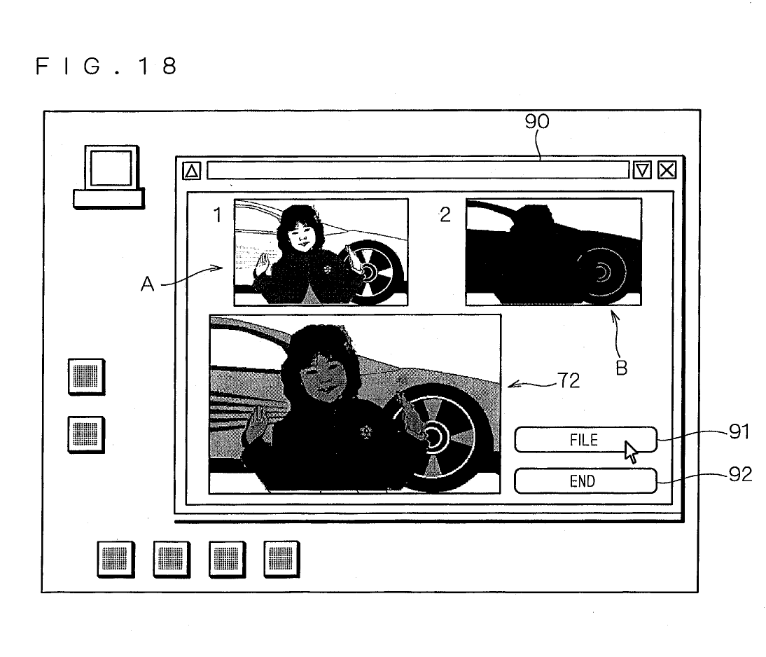

The procedure of the image processing program 75 will be described by referring to the flowchart of FIG. 17. In FIG. 16, the composite image file 70 stored in the hard disk 55 is an image file in which the composite image data 72 and the reconstruction information 74A and 74B of the original image data A and B is integrally stored as shown in FIG. 6 and so on.

The composite image file 70 is transferred from the digital camera 1 to the personal computer 50 via the memory card 8 as a medium or via the communication IF 514.

When the operator starts the image processing program 75 by operating the mouse 53 or the like, the menu screen of image reproducing applications is displayed on the display 52. Further, by performing a predetermined operation using the mouse 53 or the like, a composite file display screen 90 as shown in FIG. 18 is displayed.

When the operator selects a file button 91 by operating the mouse 53 or the like and designates the position of the composite image file 70 stored in the hard disk 55, in response to the designating operation, the composite image file 70 is read into the memory 515 (step S61).

The image processing program 75 reads the composite image file 70, and refers to the attribute information 71 recorded in the tag area 61 (step S62).

An image file format which is output in the image processing mode in the digital camera 1 includes, as described above, peculiar attribute information (“image capturing mode” item, “recording pattern” item, and the like) and the reconstruction information 74 of the original image data in the tag area. That is, the image file format includes information other than the information included in a general image format, which cannot be read by general image processing software. The image processing program 75 is a dedicated program adapted to the function of referring to the peculiar information. First, by reading the attribute information 71 in the tag area, the image processing program 75 recognizes the recording pattern of the reconstruction information 74 (step S63).

As described above, the recording pattern of the reconstruction information 74 has several styles such as the manner that the original image data is recorded as it is and the manner that the differential data between the original image data and the other original image data or the differential data between the original image data and composite image data is recorded.

Subsequently, the image processing program 75 recognizes the address of the original image data (reconstruction information 74) by referring to the “reference address” item in the attribute information 71 (step S64).

According to the recording pattern of the reconstruction information 74, the original image data A and B is reconstructed (step S65). In the case where the original image data is recorded as it is, the original image data is loaded from an address recorded in the “reference address” item. When the original image data is recorded as differential image data, a reconstructing process is performed in accordance with the pattern (such as “1D2D” or “1R2D”) recorded in the “recording pattern” item.

For example, in the example shown in FIG. 8, the image processing program 75 generates the original image data A and B by using the differential image data between the respective original image data and the composite image data. In the example shown in FIG. 9, one of the original image data (A) is loaded and, after that, the other original image data B is generated in accordance with the differential image data between the original image data A and the original image data B.

After the original image data A and B is reconstructed, the composite image data 72 is read (step S66), and the original image data A and B and composite image data 72 is displayed on the composite file display screen 90 (step S67). FIG. 18 shows a state where the original image data A and B and the composite image data 72 are displayed on the composite file display screen 90.

As described above, by reading the composite image file 70, the image processing program 75 can display the composite image data 72 and the original image data A and B used for the computing process to generate the composite image data 72. If the referred composite image is satisfactory, it is sufficient for the operator to select an end button 92 to finish the process. If the referred composite image is not satisfactory, the operator can select the end button 92 to close the display screen 90 and generate new composite image data by using proper image processing software.

That is, since the original image data A and B used for the composite computing process is included in the composite image file 70, by performing the computing process on the original image data A and B again with proper image processing software, composite image data adapted to the intention of shooting and the like can be generated.

Since the display 52 of the personal computer 50 has higher resolution as compared with the LCD 10 of the digital camera 1 and an image can be recognized in detail, a desired composite image can be generated while adjusting the addition ratio of the original image data A and B.

Although the case of reproducing the composite image file 70 output in the “tone adjusting mode” has been described above as an example, by performing a similar process on a composite image file output in the “out-of-focus adjusting mode” or “very high resolution mode”, the composite image data and the original image data can be referred to.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus comprising:
an image obtaining unit for obtaining a plurality of image data;
a composite image generator for generating composite image data by composing said plurality of image data obtained by said image obtaining unit; and
a file generator for generating a single file including the composite image data generated by said composite image generator and reconstruction information of each of the image data used for generating said composite image data.

2. The image processing apparatus according to claim 1, wherein said reconstruction information contains said image data obtained by said image obtaining unit.

3. The image processing apparatus according to claim 2, wherein said reconstruction information contains differential data between said plurality of image data obtained by said image obtaining unit.

4. The image processing apparatus according to claim 1, wherein said reconstruction information contains differential data between said composite image data and the image data obtained by said image obtaining unit.

5. The image processing apparatus according to claim 1, wherein said file is conformed with a standardized image file format and said reconstruction information is recorded in an undefined area in said image file format.

6. The image processing apparatus according to claim 1, wherein said image processing apparatus is a digital camera.

7. A program product recording a program for enabling a data processor to execute the following process comprising the steps of:
obtaining a plurality of image data;
generating composite image data by combining said plurality of image data; and
generating a single file containing said composite image data and reconstruction information of each of the image data used for generating said composite image data.

8. An image processing apparatus comprising:
an image obtaining unit for obtaining a plurality of image data at different exposures;
a composite image generator for combining said plurality of image data obtained by said image obtaining unit to thereby generate composite image data having the larger number of torn levels than that of said image data obtained by said image obtaining unit; and
a file generator for generating a single file including the composite image data generated by said composite image generator and each of the image data used for generating said composite image data.

9. A program product recording a program for enabling a data processor to execute the following process comprising the steps of:
obtaining a plurality of image data at different exposures;
combining said plurality of image data to thereby generate composite image data having the larger number of torn levels than that of said image data obtained by said image obtaining unit; and
generating a single file containing said generated composite image data and each of the image data used for generating said composite image data.

10. An image reproducing apparatus comprising:
an input unit for inputting an image file recording composite image data and reconstruction information of a plurality of image data used for generating said composite image data;
a first reproducer for reproducing said composite image data;
a generator for generating reconstructed image of said plurality of image data in accordance with said reconstruction information; and
a second reproducer for reproducing the reconstructed image generated by said generator.

11. A program product recording a program for enabling a data processor to execute the following process comprising the steps of:
inputting an image file recording composite image data and reconstruction information of a plurality of image data used for generating said composite image data;
generating reconstructed image of said plurality of image data in accordance with said reconstruction information; and
reproducing said composite image data and said reconstructed image.
